(19) United States
(12) Patent Application Publication
(10) Pub. No.: US 2010/0117941 A1
(43) Pub. Date: May 13, 2010

(54) COLOR-CONTROLLED BACKLIT DISPLAY DEVICE

(75) Inventor: Volkmar Schulz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/523,535

(22) PCT Filed: Jan. 18, 2008
(86) PCT No.: PCT/IB08/50185

§ 371 Date: Dec. 30, 2009

(30) Foreign Application Priority Data
Jan. 23, 2007 (EP) 07100961.7

(51) Int. Cl. G09G 3/36

(52) U.S. Cl. 345/88

(57) ABSTRACT

A device and method are described for a color-controlled backlit display device (100), which device and method employ a feedback-detected color value that is processed so as to equal the output light of the display. The device comprises a plurality of light sources (103), a light output unit (101) comprising a display element (106), a first color-rendering optical element (105), a color control unit (104), a first light-mixing device (102), and a light detection unit (107) comprising a color sensor (108). The color control unit controls the light generated by means of the light sources on the basis of a nominal predefined color value and the detected color value, wherein the generated light is mixed by the first light-mixing device and passed through the light output unit. A minor part of the mixed generated light is detected by the light detection unit, which generates the detected color value that is fed back to the color control unit. The light detection unit further comprises a second color-rendering optical element (109) for processing the light entering the color sensor so as to equal the light leaving the light output unit.

### FIELD OF THE INVENTION

The present invention relates in general to a backlight system for LCD-displays or other electronic displays, and more particularly to a color-controlled backlit display device.

### BACKGROUND OF THE INVENTION

Future liquid crystal display (LCD) backlight systems will most likely be based on saturated primary colors so as to enlarge the color gamut of the next generation of LCD displays. Light-emitting diodes (LEDs) are advantageous for this type of backlighting, partly because of their low power consumption and low supply voltage, but more importantly because of the relatively narrow color spectrum of the produced light (when non-white).

There are several known concepts of generating backlight with LEDs. One is direct conversion in which light from multiple monochromatic LEDs (RGB, RGBA, and RGCBA, in which R stands for Red, G for Green, B for Blue, A for Amber, and C for Cyan) is mixed, resulting in white light. Another concept is phosphor conversion, in which a blue or ultraviolet (UV) chip is coated with phosphor so as to emit white light. The phosphor conversion approach is most commonly based on blue LEDs. When combined with a yellow phosphor (usually cerium-doped yttrium aluminum garnet or YAG:Ce), the light will appear white to the human eye. Another approach uses LEDs emitting in the near-UV range of the spectrum, which near-UV light is used to excite multichromatic phosphors for generating white light.

Each of these concepts has its specific advantages and drawbacks. Due to the variation of the color of the LED on, for instance, bin, temperature and current, all concepts require a precise color control.

The prior art discloses a number of color control systems. U.S. Pat. No. 7,002,546 B1 discloses a color-controlled backlit display device, which has a backlit LCD display element and a color control unit which controls the generated light on the basis of color values of luminance and chromaticity. The generated light from the LEDs is detected with an internal detector, which is situated on the same printing board as the LEDs and is connected to a processor and control unit. The control unit adjusts the generated light with regard to luminance and chromaticity before the light passes through a mixing device and is then further guided to the LCD-light output device. By placing the light detector within the display device, the detected color value of the generated light only comprises information concerning internally changing parameters, such as LED temperatures and currents. No information concerning the actual output light of the LCD-light output device is fed back to the control unit. Consequently, the adjustments of said control unit are made blindly, with no concern being taken to alter the generated light because of, for instance, ageing of the LCD-light output device.

### OBJECT AND SUMMARY OF THE INVENTION

It is an object of the present invention to at least partly alleviate the above-mentioned drawbacks of the prior art.

This object is achieved by a color-controlled display device according to the present invention as defined in claim 1, as well as by a method of controlling light generation in a backlit color display device as defined in claim 9.

Thus, in accordance with a first aspect of the present invention, a color-controlled backlit display device comprises a light output unit, which includes a display element and a first color-rendering optical element, a plurality of light sources, a color control unit, a first light-mixing device, and a light detection unit comprising a color sensor. The color control unit controls the light generated by means of said plurality of light sources on the basis of a nominal predefined color value and a detected color value. The generated light is mixed by the first light-mixing device and passed through the light output unit. The mixed generated light is detected by the light detection unit, which generates the detected color value. The light detection unit further comprises a second color-rendering optical element for processing the light entering the color sensor so as to equal the light leaving the light output unit.

By processing part of the generated light so as to equal the light leaving the light output unit, the color control unit receives a realistic color value of the generated light as seen by a viewer. This provides the advantage that not only, for instance, color variations caused by changes in temperature and current of the light sources that generate the light and/or binning effects are included in the detected color value of the generated light fed back to the color control unit, but also a prediction of color value-altering effects caused by the color-rendering optical element of the light output unit. A fact that has been overlooked in the prior art is that the color-rendering optical elements in the light output unit will influence the output light of the display due to, for instance, ageing of the optical elements, interaction between the optical elements and the light sources, etc.

It should be noted that, in this application, the color value is any kind of useful value related to the color, or color properties, of the output light. A person skilled in the art will be able to determine what kinds of values are useful, but some examples are color temperature, R, G and B-filtered intensity values of the generated light, etc.

In accordance with an embodiment of the color-controlled backlit display device as defined in claim 2, the first light-mixing device is extended so as to guide the mixed generated light to the second color-rendering optical element. The internal light detector unit, which includes the second color-rendering optical element, can thus be positioned in an advantageous way. Hence, the risk of detecting misrepresentations of the generated mixed light due to a poorly positioned light detection unit is reduced.

In accordance with an embodiment of the color-controlled backlit display device as defined in claim 3, the first and the second color-rendering optical element are identical. This ensures that the operation of processing part of the generated light results in a realistic prediction of the light output from the display device. “Identical” is herein understood to mean that the color-rendering elements treat the light in the same way, and, typically, have the same type of parts. However, as will be evident to the skilled person, it typically does not mean that the size of the second color-rendering element equals the size of the first color-rendering element. On the contrary, the size of the second color-rendering element is typically but a fraction of the size of the first color-rendering element.

In accordance with an embodiment of the color-controlled backlit display device as defined in claim 4, the color sensor is one of an internal true-color RGB sensor and an internal XYZ-sensor.

In accordance with an embodiment of the color-controlled backlit display device as defined in claim 5, the color sensor is an optical spectrometer having a significant resolution.

In accordance with an embodiment of the color-controlled backlit display device as defined in claim 6, further processing so as to make the light reaching the color sensor resemble the actual light output from the display device as seen by a viewer is achieved by means of a second light-mixing device. The second color-rendering optical element and said color sensor are arranged on opposite sides of the second light-mixing device.

In accordance with an embodiment of the color-controlled backlit display device as defined in claim 7, the first and the second color-rendering optical element are color filters.

In accordance with an embodiment of the color-controlled backlit display device as defined in claim 8, the first and the second color-rendering optical element are phosphor plates.

In accordance with a second aspect of the present invention, a method of controlling light generation in a backlit color display device, as defined in claim 9, comprises the steps of:

generating colored light,

mixing the generated light,

color-rendering processing, in a first light path, a major part of the mixed generated light and outputting the processed light as output light, and

controlling said generation of colored light on the basis of a nominal predefined color value and a detected color value,

wherein said control step comprises repeatedly:

color-rendering processing, in a second light path, a minor part of the mixed generated light so as to equal said output light,

detecting the processed mixed generated light in said second light path, and

generating a detected color value,

comparing the detected color value with said nominal predefined color value, and, if the detected color value and the predefined color value do not match:

adjusting the generated colored light so as to match the detected color value with the nominal predefined color value.

By performing the steps of the method in accordance with to this aspect of the invention, color control of a display device can thus be managed in a way in which part of the generated light is internally processed so as to equal the output light from the display device, hence taking the influence of the light output unit of the display device on the generated light into account.

The above and further objects, advantages and features are apparent from and will be elucidated with reference to the embodiments described hereinafter.

### BRIEF DESCRIPTION OF THE DRAWINGS

The invention and its many advantages will be described in more detail below with reference to the accompanying schematic drawings, which show some non-limiting embodiments for the purpose of illustration and in which:

FIG. 1 is a block diagram of a display device according to the present invention;

FIG. 2 is a cross-section of an LCD backlight device in accordance with an embodiment of the display device according to the invention;

FIG. 3 is a cross-section of a remote-phosphor LCD backlight device in accordance with another embodiment of the display device;

FIG. 4 is a simplified flowchart of a method of controlling light generation in a backlit color display device according to the present invention.

All Figures are highly schematic and not necessarily drawn to scale. They show only parts which are necessary to elucidate the invention, while other parts are omitted or merely suggested.

### DESCRIPTION OF EMBODIMENTS

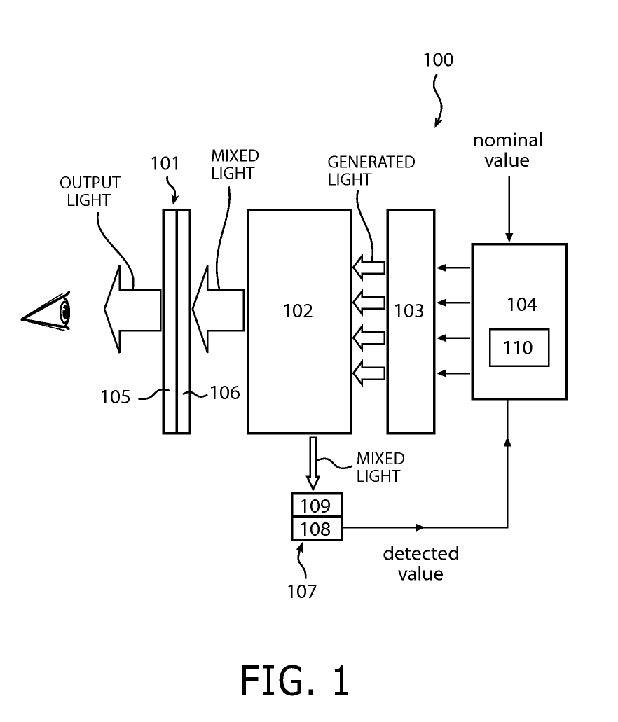

FIG. 1 shows a general structure of a color-controlled backlit display device according to the present invention. The display device 100 comprises a plurality of light sources 103 and a color control unit 104, which is connected to the light sources 103 for controlling the emitted light on the basis of a predefined nominal color value and a detected color value. The color control unit 104 comprises means for individually driving the light sources 103.

The display device 100 further comprises a light-mixing device 102, placed in front of the light sources 103, for mixing the generated light and for guiding the generated light to a light output unit 101.

The light output unit 101 comprises a first color-rendering optical element 105 and a display element 106, which elements, i.e. 105 and 106, can be arranged either with the color-rendering element 105 facing the light-mixing device 102 or with the display element 106 facing the light-mixing device 102, depending on what particular light generation concept is utilized in the display device 100.

The generated light passes through the light output unit 101 and results in the output light as seen by a viewer in front of the display device 100. The display device 100 further comprises an internal light detection unit 107, which is arranged inside the display device 100 in connection with the light-mixing unit 102, for detecting part of the mixed light from the light-mixing device 102.

The light detection unit 107 is connected to the color control unit 104.

For detecting a realistic metric of the generated output light, as seen by a viewer, the detection unit 107 comprises a color sensor 108 and a second color-rendering optical element 109 for processing the light entering the color sensor 108 so as to equal the output light. The light detection unit 107 generates said detected color value, and the detected color value is then provided to the color control unit 104 as a feedback color value of the generated mixed light.

The color control unit 104 comprises means for comparing said detected color value and the predefined nominal color value, said means being, for instance, a comparator circuit 110. If the nominal color value and the detected color value do not correspond, the color control unit 104 will adjust the driving signals of the light sources 103 accordingly so as to obliterate the difference.

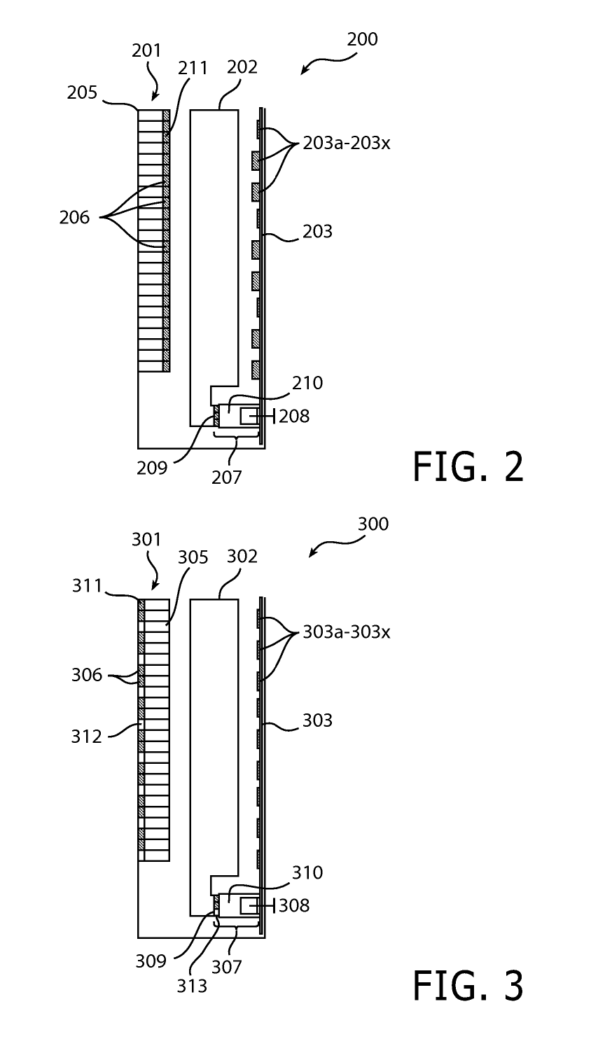

In accordance with a first embodiment of the color-controlled backlit display device 200, as shown in FIG. 2, in which only the lower part of the cross-section of the display device is shown, the display device 200 utilizes a light generation concept based on RGB-filters and a plurality of phosphor-converted LEDs (pcLEDs) 203a-203x as light sources. The generated light is mixed and homogenized in a light-mixing guide, i.e. a diffuse light guide 202, placed between the light sources 203 and a light output unit 201. The main part of the mixed light passes through the light output unit 201. In this embodiment, the display element of the light output unit is an LCD-pixel matrix 205 and the color-rendering optical element 211 consists of RGB-filters 206.

A portion of the generated mixed light is input to a light detection unit 207 for providing a feedback value to the color control unit 104 (which is not shown in FIG. 2). In this embodiment, the diffuse light guide 202 is extended so as to guide part of the generated mixed light to the light detection unit 207. The form of the extension is customized for the particular positioning of the light detection unit.

In this embodiment, the light detection unit 207 comprises a true-color RGB-sensor 208, an RGB-filter 209 as a second color-rendering optical element, and a second light-mixing device, i.e. a second diffuse light guide 210. The RGB-filter 209 and the true-color RGB-sensor 208 are arranged on opposite sides of the second light-mixing device 210. In an alternative embodiment, the second light-mixing device 210 is realized as a translucent block. If required, the predefined directivity of the light reaching the color sensor 208 is taken into account in the design of the RGB-filter 209. Narrow-beam requirements of the RGB-sensor may be realized via an additional collimator structure placed in front of the true-color RGB-sensor.

In the embodiment of the display device as shown in FIG. 2, the second color-rendering element, i.e. the RGB-filter 209, is chosen to be identical to the first color-rendering element 211, i.e. the RGB-filters 206. More particularly, the corresponding parts of the first and second color-rendering elements 211, 209 are of the same types, while the size of the second color-rendering element 209 is but a small fraction of the size of the first color-rendering element 211. The purpose of this is to process the detected color value of the generated mixed light so as to equal the output light from the display device.

In a second embodiment of the color-controlled backlit display device 300, as shown in FIG. 3, in which only the lower part of the cross-section of the display device is shown, the display device utilizes a light generation concept based on the remote-phosphor technique. The plurality of light sources 303 in the device consists of blue LEDs 303a-303x. The generated light is then mixed and homogenized in a light-mixing guide, i.e. a diffuse light guide 302, which is placed between the LEDs 303a-303x and the light output unit 301. The main part of the mixed light then passes through the light output unit 301. In this embodiment, the display element of the light output unit 301 is an LCD-pixel matrix 305, and the first color-rendering optical element 311 consists of RG-phosphor plates 306 and transparent windows 312.

A portion of the generated mixed light is supplied to the light detection unit 307 for generating a detection value to be fed back to the color control unit 104 (which is not shown in FIG. 3). As described above, this is advantageously done by means of an extended light guide 302.

In this embodiment, the light detection unit 307 comprises a true-color RGB-sensor 308, RG-phosphor plates 309 in combination with a transparent window 313 as a second color-rendering optical element, and a second light-mixing device, i.e. a second diffuse light guide 310. The RG-phosphor plates 309 in combination with the transparent window 311 and the true-color RGB-sensor 308 are arranged on opposite sides of the second light-mixing device 310.

In accordance with another embodiment of the invention, the color sensor is realized by using an XYZ-sensor. It is to be understood that embodiments of the invention using other types of equivalent color sensors fall within the scope of the present invention.

In the embodiment shown in FIG. 3, the second color-rendering element, i.e. the RG-phosphor plates 309 in combination with the transparent window 313, is chosen to be identical to the first color-rendering element 311, i.e. the RG-phosphor plates 306 and transparent windows 312. The purpose of this is to process the detected color value of the generated mixed light so as to equal the output light from the display device.

Types of color-rendering elements other than RGB-filters and RG-phosphor plates are possible and fall within the scope of the invention.

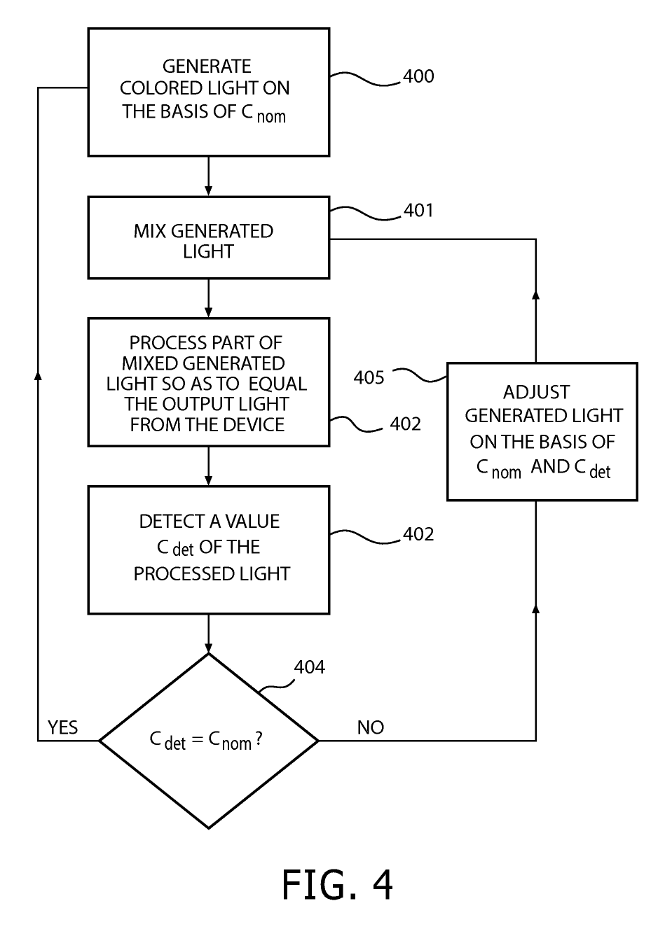

A further aspect of the present invention is a method of controlling light generation in a color-controlled display device, as illustrated in FIG. 4. In an embodiment of the method of color-controlling a backlit color display device 100 as described above (FIG. 1), the method comprises the steps as described hereinafter with reference to FIG. 4.

In step 400, the color control unit 104, which has a predefined nominal color value Cₙₒₘ, sets the driving voltages for the colored light sources 103 on the basis of Cₙₒₘ. Then, in step 401, the generated light is mixed in the light-mixing unit 102 and the major part of the mixed light is subsequently passed through the light output 101, resulting in the output light, while, in step 402, part of the mixed generated light is color-rendering processed in a separate light path so as to equal the output light from the display device. The processing operation is performed by the color-rendering optical element 109.

In step 403, a detected color value C_{det} of the processed light is generated by color sensor 108, which detected value is supplied to the color control unit 104.

Step 404 includes comparison of the detected color value C_{det} with said nominal predefined color value Cₙₒₘ and is performed by the color control unit 104. If C_{det} equals Cₙₒₘ, the method returns to step 400 and repeats steps 400 to 404 as described above, or else, if C_{det} does not match Cₙₒₘ, the driving of the color sources is adjusted to generate colored light so as to match the detected color value C_{det} with the predefined nominal color value Cₙₒₘ, in step 405. Subsequently, the method returns to step 401 and continues through steps 401 to 404 as described above.

As is known to a person skilled in the art, matching of the detected color value value C_{det} with the predefined nominal color value Cₙₒₘ will typically only be possible within a certain tolerance.

The color-control technique according to the present invention applies to various light generation concepts as direct conversion based on, for instance, RGB, RGBA, and RGCBA LEDS, remote-phosphor RG in combination with direct blue LEDs, phosphor-converted RG in combination with direct blue LEDs, phosphor white in combination with direct RGB LEDs, and UV or infrared pumped phosphor systems.

Light sources other than LEDs in the light generation concept are possible and fall within the scope of the invention.

The present color-control technique also applies to general illumination such as large-area light tiles and flat light sources in, for instance, shops, homes, etc.

Although the invention has been described with reference to preferred embodiments, it will be evident to those skilled in the art that several modifications are conceivable without departing from the scope of the invention as defined by the following claims.

It is to be noted that, for the purposes of this application and in particular with regard to the appended claims, use of the verb “comprise” and its conjugations does not exclude other elements or steps, and that the article “a” or “an” does not exclude a plurality of elements or steps, as will per se be apparent to those skilled in the art.

1. A color-controlled backlit display device (100) comprising:
a light output unit (101) comprising a display element (106) and a first color-rendering optical element (105);
a plurality of light sources (103);
a color control unit (104);
a first light-mixing device (102); and
a light detection unit (107) comprising a color sensor (108);
wherein said color control unit controls the light generated by means of said plurality of light sources on the basis of a nominal predefined color value and a detected color value, wherein the generated light is mixed by said first light-mixing device and passed through said light output unit, and wherein the mixed generated light is detected by said light detection unit, which generates said detected color value; and
wherein said light detection unit further comprises a second color-rendering optical element (109) for processing the light entering the color sensor so as to equal the light leaving said light output unit, and
wherein said first light-mixing device is extended so as to guide the mixed generated light to said second color-rendering optical element

2-3. (canceled)

4. A device according to claim 1, wherein the color sensor is one of an internal true-color RGB sensor or an internal XYZ-sensor.

5. A device according to claim 1, wherein the color sensor is an optical spectrometer having a significant resolution.

6. A device according to claim 1, further comprising a second light-mixing device, wherein said second color-rendering optical element and said color sensor are arranged on opposite sides of said second light-mixing device.

7. A device according to claim 1, wherein said first and said second color-rendering optical element are color filters.

8. A device according to claim 1, wherein said first and said second color-rendering optical element are phosphor plates.

9. A method of controlling light generation in a backlit color display device, the method comprising the steps of:
generating colored light (400);
mixing the generated light (401);
color-rendering processing, in a first light path, a major part of the mixed generated light and outputting the processed light as output light; and
controlling said generation of colored light on the basis of a nominal predefined color value and a detected color value;
wherein said control step repeatedly comprises:
color-rendering processing, in a second light path, a minor part of the mixed generated light so as to equal said output light (402);
detecting the processed mixed generated light in said second light path, and generating a detected color value (403);
comparing the detected color value with said nominal predefined color value (404); and, if the detected color value and the predefined color value do not match:
adjusting the generated colored light so as to match the detected color value with the nominal predefined color value.
